(19) United States
(12) Patent Application Publication
(10) Pub. No.: US 2024/0077753 A1
(43) Pub. Date: Mar. 7, 2024

(54) BIDIRECTIONAL BATTERY CHARGING AND DISCHARGING

(71) Applicant: Google LLC, Mountain View, CA (US)

(72) Inventors: Philip Isaacs, Kitchener (CA); Kai Xu, Mississauga (CA)

(21) Appl. No.: 18/262,669

(22) PCT Filed: Jan. 26, 2022
(86) PCT No.: PCT/US2022/070357

§ 371 Date: Jul. 24, 2023

Related U.S. Application Data
(60) Provisional application No. 63/199,824, filed on Jan. 27, 2021.

(51) Int. Cl. G02C 11/00; G02B 27/01; H02J 7/00; H02J 7/34

(52) U.S. Cl. CPC G02C 11/10; G02B 27/017; H02J 7/0013; H02J 7/00714; H02J 7/342; G02B 2027/0178

(57) ABSTRACT

In a general aspect, an electronic device can include a first battery cell, a second battery cell, a system power bus and a system load coupled with the system power bus. The device can also include a first bidirectional controller that is operationally coupled between the system power bus and the first battery cell. The first bidirectional controller can be configured to control a charging current and a charging voltage of the first battery cell, control a discharge current of the first battery cell. The device can further include a second bidirectional controller operationally coupled between the system power bus and the second battery cell. The second bidirectional controller can be configured to control a charging current and a charging voltage of the second battery cell, and control a discharge current of the second battery cell.

### CROSS-REFERENCE TO RELATED APPLICATION

This application claims priority to, and the benefit of, U.S. Provisional Patent Application No. 63/199,824, filed on Jan. 27, 2021, entitled “BIDIRECTIONAL BATTERY CHARGING AND DISCHARGING”, the disclosure of which is incorporated by reference herein in its entirety.

### TECHNICAL FIELD

This disclosure relates to electronic devices with rechargeable power sources. More specifically, this disclosure is directed to charging control and discharging control in electronic devices with multiple rechargeable power sources, such as rechargeable batteries.

### BACKGROUND

Advances in consumer electronics have provided increases in features and functionality that is implemented in lightweight devices, such as smartphones, smart glasses, and/or augmented-reality or virtual-reality appliances (e.g., head-mounted displays). Due, for example, to size and weight limitations, implementing rechargeable power sources, such as rechargeable batteries, in such devices can be challenging. For instance, battery size and/or weight can be limited, as can area for implementing low resistance electrical connections, such as power supply connections. To provide additional power supply capacity for components in an electronic device, multiple batteries can be included.

However, charging multiple batteries and providing power to components of an associated electronic device with those batteries, whether connected in series or in parallel, can present a number of challenges. For instances the number of power connections used, e.g., three or more, can, due to limited space for electrical connections, result in those power connections having resistances that adversely impact charging and power delivery efficiency, and can also require the use of multiple chargers, or chargers with multiple battery connections to charge the batteries. Also in devices with multiple batteries, differences in respective electrical loads, or respective impedances as associated with the batteries can result in unbalanced charging and/or discharging. Further, batteries connected in series can limit power conversion efficiency for charging and/or discharging, and can also result in combined voltages that exceed limits of available protection circuits that prevent damage to the batteries (battery cells), and/or prevent hazardous conditions. Other drawbacks also exist, such as inadequate protection of parallel connected batteries, for example.

### SUMMARY

In a general aspect, an electronic device can include a first battery cell, a second battery cell, a system power bus, and a system load coupled with the system power bus. The electronic device can also include a first bidirectional controller operationally coupled between the system power bus and the first battery cell. The first bidirectional controller can be configured to control a charging current and a charging voltage of the first battery cell, and control a discharge current of the first battery cell. The electronic device can further include a second bidirectional controller operationally coupled between the system power bus and the second battery cell. The second bidirectional controller can be configured to control a charging current and a charging voltage of the second battery cell, and control a discharge current of the second battery cell.

For example, this disclosure relates to a smart glasses system comprising a frame including: a first temple; a second temple; and a lens portion; a first battery cell included in the first temple; a second battery cell included in the second temple; a system power bus coupled with the first battery cell and the second battery cell, the system power bus being included in the frame; a system load coupled with the system power bus, the system load including at least one component of the smart glasses system; a first bidirectional controller operationally coupled between the system power bus and the first battery cell, the first bidirectional controller being configured to: control a charging current and a charging voltage of the first battery cell; and control a discharge current of the first battery cell; and a second bidirectional controller operationally coupled between the system power bus and the second battery cell, the second bidirectional controller being configured to: control a charging current and a charging voltage of the second battery cell; and control a discharge current of the second battery cell. The smart glass system may be an internet enabled smart glass system.

In another aspect, this disclosure relates to an electronic device comprising: a first battery cell; a second battery cell; a system power bus; a system load coupled with the system power bus; a first bidirectional controller operationally coupled between the system power bus and the first battery cell, the first bidirectional controller being configured to: control a charging current and a charging voltage of the first battery cell; and control a discharge current of the first battery cell; and a second bidirectional controller operationally coupled between the system power bus and the second battery cell, the second bidirectional controller being configured to: control a charging current and a charging voltage of the second battery cell; and control a discharge current of the second battery cell. The electronic device may be included in an electronic system such as a smart glasses system described above, a heads-up display, a smartphone, and so forth.

The disclosure also relates to a method for controlling battery charging and discharging in an electronic device having a first battery cell, a second battery cell, a system power bus and a system load coupled with the system power bus, the method comprising: with a first bidirectional controller operationally coupled between the system power bus and the first battery cell: controlling a charging current and a charging voltage of the first battery cell; and controlling a discharge current of the first battery cell; and with a second bidirectional controller operationally coupled between the system power bus and the second battery cell: controlling a charging current and a charging voltage of the second battery cell; and controlling a discharge current of the second battery cell.

The electronic device may also comprise the first and the second bidirectional controller. Further, the electronic device may be included in an electronic system such as a smart glasses system described above, a heads-up display, a smartphone, and so forth.

### BRIEF DESCRIPTION OF THE DRAWINGS

FIG. 1 is a diagram that schematically illustrates a pair of smart glasses including bidirectional, multi-battery charging and discharging.

FIG. 2 is a block diagram that schematically illustrates a bidirectional, multi-battery charging and discharging system.

FIG. 3 is a block diagram that schematically illustrates an integrated bidirectional controller and battery (battery pack) that can be implemented in the system of FIG. 2.

FIGS. 4A and 4B are graphs that schematically illustrate approaches for current control in the system of FIG. 2 and/or the controller of FIG. 3.

FIG. 5 shows an example of a computing device and a mobile computing device, which can be used to implement the techniques described herein.

### DETAILED DESCRIPTION

This disclosure is directed to approaches for controlling charging and discharging of multiple, parallel-connected batteries in an electronic device. The example implementations described herein can address at least some of the drawbacks and challenges of current approaches, such as those discussed above. For purposes of illustration and by way of example, the approaches described herein are discussed in the context of a pair of smart glasses (glasses) with multiple batteries. For instance, in some implementation, multiple batteries can be included, e.g., a respective battery can be included in each temple of the glasses.

Also for purposes of illustration and by way of example, the approaches discussed herein are described as using a Universal Serial Bus (USB) connection for battery charging, e.g., via a system voltage power bus (VSYS), and also using VSYS for providing power to components of the smart glasses from the batteries, e.g., discharging the batteries. That is, the approaches described herein can include bidirectional charging and discharging control over a single power bus (e.g., VSYS and an electrical ground connection). While the example implementations described herein are given in the context of smart glasses and using VSYS for charging (e.g., via a USB connection) and discharging, in some implementations, these approaches can be implemented in other electronic devices, and/or using other approaches for charging and/or discharging, such as using an independent direct-current (DC) charging power source, and using a single, shared power bus for charging and discharging multiple, parallel-connected batteries in an electronic device or system.

In example smart glasses implementations, multiple batteries can be implemented in parallel, where components of the glasses can be powered by the parallel combination of batteries. In such implementations, electrical connections, such as VSYS and an associated electrical ground, can be routed over a bridge of the glasses and/or through hinges of the glasses. As noted above, providing such electrical connections can be challenging due to a limited amount of cross sectional area for implementing electrical connectors, such as copper traces, e.g., in the bridge and/or hinges. The approaches described herein provide for charging multiple batteries from a single charge point, which allows charging current and discharging current to be carried over a common or shared power bus, e.g., including two electrical connectors, such as VSYS and electrical ground. Accordingly, the described approaches can reduce resistance of the power bus connections by fifty percent or more, as compared to current approaches that use three or more electrical connections, such as one for charging, one for discharging, and an electrical ground. Further, in some implementations, balancing discharge between batteries during use can be achieved using the approaches described herein, which may not be possible in current implementations.

Example implementations, such as those described, can include, for each battery or battery cell of an electronic device, a bidirectional controller that is coupled between an associated power bus, such as VSYS, and the respective battery. In such implementations, a bidirectional controller can be configured to control charging of its associated battery, e.g., when a charging power source is applied to VSYS, and also control discharge of the battery using VSYS to supply power to components of a corresponding electronic device.

In example implementations, during battery charging, charging power can be applied to VSYS, and when VSYS is determined to be above a voltage of the respective battery (VBAT), e.g., by a threshold amount, the bidirectional controller can charge the respective battery at a predetermined rate, e.g., either using constant current charging or constant voltage charging. During discharge, when charging power is removed and a battery voltage is above VSYS, the bidirectional charger will change power flow direction, so that its respective battery, along with other batteries in the device, can supply power to components of the device couple with VSYS.

Another advantage of the example implementations described herein, is the use of shared power supply connections to charge multiple, parallel batteries, as well as to supply power to components of an associated electronic device, can allow for flexibility in locating charging contacts. For instance, using VSYS for charging and discharging can allow for contacts to connect a charging power supply to be flexibly located in an electronic device (e.g., where the charging contacts can be electrically coupled with VSYS and an associated electrical ground). In some implementations, a corresponding electronic device can be run (e.g., operated) directly off a charging power supply voltage. For instance, in a USB implementation, VBUS (typically 5V) can be directly applied on VSYS, or can be stepped down to a voltage that is greater than (by a threshold amount) or equal to a voltage of the associated battery. Further, the approaches described herein can be used to protect parallel-implemented batteries from damage during charging and/or discharging, and prevent associated dangerous conditions, which can include thermal runaway, fire, damage to the battery cells, and/or reduced charge storage capacity of the battery cells.

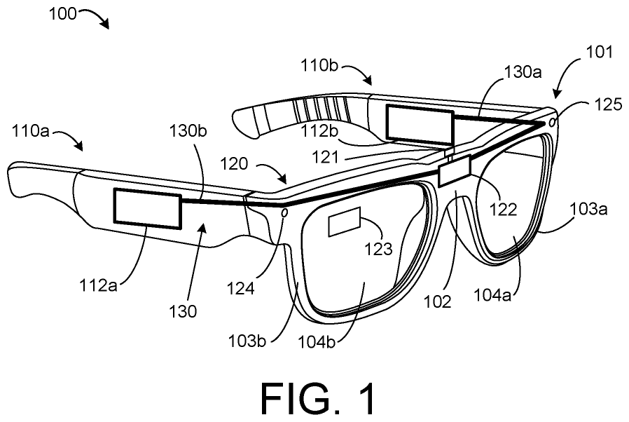

FIG. 1 is a diagram that schematically illustrates a smart glasses system in the form of a pair of smart glasses (glasses 100) including bidirectional, multi-battery charging and discharging using a common power supply bus (e.g., VSYS and electrical ground). As shown in FIG. 1, the glasses 100 include a frame 101 that includes a first temple 110a, a second temple 110b, and a lens portion 120. The glasses 100 also includes a power supply bus (system power bus VSYS 130) that is implemented in the frame 101. In this example, the lens portion 120 includes a bridge portion 102, and lenses 104a and 104b that are contained within (e.g., secured in place by) respective rim portions 103a and 103b. Further in this example, an electrical ground is also included with VSYS 130. As shown in FIG. 1, the first temple 110a includes a first battery (battery cell) 112a coupled with a first portion 130a of VSYS 130, and the second temple 110b includes a second battery (battery cell) 112b coupled with a second portion 130b of VSYS 130, where the first portion 130a and the second portion 130b are electrically continuous for carrying power when charging, in a first direction, and power when discharging, in a second direction. In this example, the portions 130a and 130b of VSYS 130 can be included (routed, etc.) in, or on the bridge portion 102, the rim portions 103a and 103b, and the temples 110a and 110b. The first battery 112a and the second battery 112b can be batteries of a same capacity, or batteries of different capacities. In some implementations, the glasses 100 can include additional batteries that are similarly coupled with VSYS 130, as with the first battery 112a and the second battery 112b.

As shown in FIG. 1, the glasses 100 include an input port 121, which can be a USB port, that is operationally coupled with an input power regulator 122. In the glasses 100 the input port 121 and the input power regulator 122 are located in the lens portion 120, e.g., on, or in the bridge portion 102. However, in some implementations, the input port 121 and the input power regulator 122 could be implemented in another part of the glasses 100, such as in one of the temples, e.g., where access to electrical connections of VSYS 130 is available. In this example, the input power regulator 122, when a charging power source, e.g., a powered USB cable, can be coupled with the input port 121, and can provide charging power to the first battery 112a and the second battery 112b. The first battery 112a and the second battery 112b can be implemented as battery packs that include respective bidirectional charging/discharging controllers, such the controllers described herein. When a charging power source is not coupled to the glasses 100 via the input port 121, power can be supplied from the first battery 112a and second battery 112b to operate components of the glasses 100, such as a heads-up display 123, a camera 124, and a microphone 125. The components of the glasses 100 in FIG. 1 are provided by way of example. In some implementations, an electronic device, such as the glasses 100, can include additional components, and/or different components.

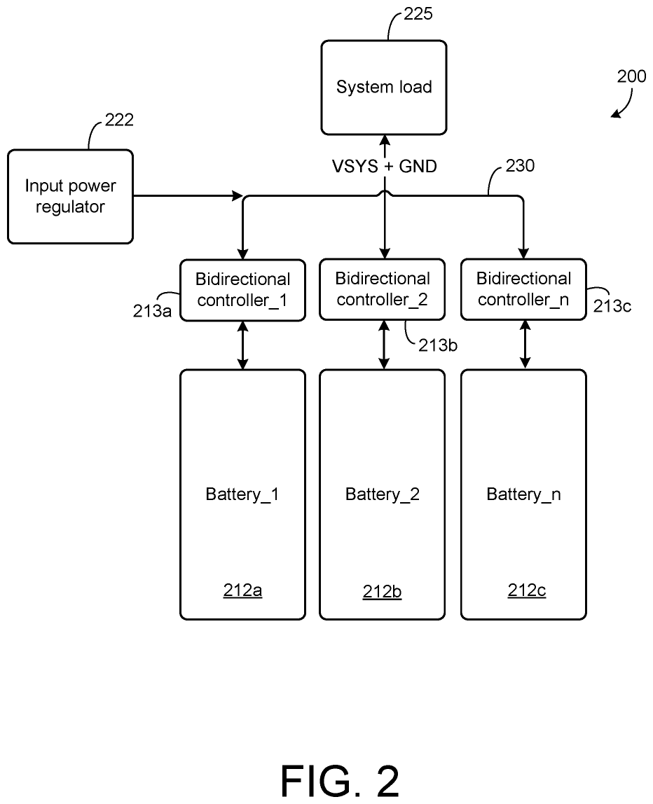

FIG. 2 is a block diagram that schematically illustrates an electronic device in the form of a bidirectional, multi-battery charging and discharging system, e.g., system 200. In some implementations, the system 200 can be included in the glasses 100, or can be included in other electronic systems, such as heads-up displays, smartphones, and so forth. As shown in FIG. 2, the system 200 can include a battery_1 212a, a battery_2 212b and a battery_n 212c. As indicated in FIG. 2, the system can include two or more batteries. That is, in some implementations, the battery_n 212c could be eliminated, or additional batteries could be included.

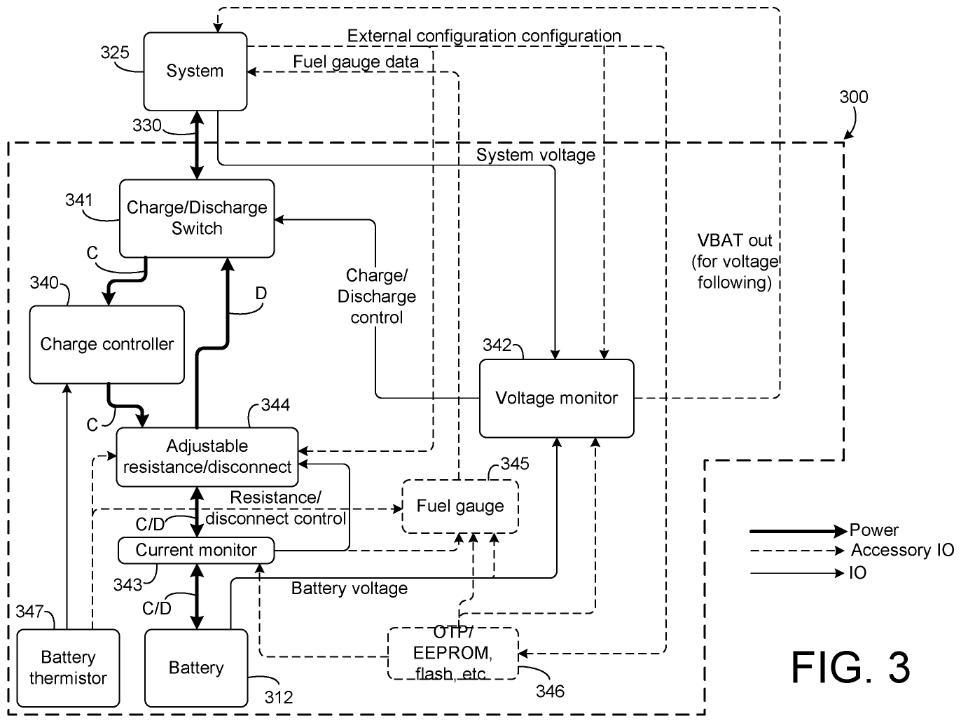

As also shown in FIG. 2, each of the batteries of the system 200 is coupled with a respective bidirectional charging and discharging controller. For instance, the system 200 includes a controller_1 213a operationally coupled with the battery_1 212a, a controller_2 213b operationally coupled with the battery 212b, and a controller_n 213c operationally coupled with the battery_n 212c. As with the batteries, the system 200 can include two or more such controllers, e.g., in a one-to-one ratio with included batteries. As noted above, each battery and its respective controller of the system 200 can be integrated in a respective battery pack. For instance, such a controllers can be implemented as an integrated circuit that is included in a battery pack with a rechargeable battery cell, such as a lithium-ion battery, such as in the specific example shown in FIG. 3.

The system 200 further includes an input power regulator 222, which can receive and regulate power from a charging power source, such as a VBUS voltage from a USB cable, and apply that regulated power to a system power bus 230, which can include VSYS and electrical ground. That applied power can, using the approaches described herein, be used to charge the batteries of the system 200, as controlled by their respective bidirectional controllers. The power applied to the system power bus 230 can also be used to power the system load 225, which can include components of an associated electronic system, such as components of the glasses 100 discussed above with respect to FIG. 1.

Further, when a charging power source is not connected to the input power regulator 222, power can be supplied to the system load 225 from the batteries of the system 200, e.g., via the bidirectional controllers. That is, as is indicated in FIG. 2, the system power bus 230 (VSYS) can be used for delivering system power to the system load 225, whether from the input power regulator 222 or the batteries, and for charging power for the batteries, e.g., using power provided by the input power regulator 222.

FIG. 3 is a block diagram that schematically illustrates an integrated bidirectional controller and battery (battery pack 300) that can be implemented, e.g., in the glasses 100 of FIG. 1 and/or the system 200 of FIG. 2. For instance, the battery pack 300 includes a rechargeable battery 312, that is integrated with a bidirectional charging/discharging controller. In this example, the bidirectional charging/discharging controller includes at least one of a charging controller 340, a charge/discharge switch (switch 341), a voltage monitor 342, a current monitor 343, an adjustable resistance/disconnect circuit (adjustable circuit 344) a fuel gauge 345, a non-volatile memory 346 (e.g., a one-time programmable, EEPROM, or flash memory) and a thermistor 347. Each of the blocks, and examples of their operation and interaction for charging and/or discharging control are described below. In other examples, a bi-directional charging/discharging controller can have other configurations, and/or can include additional elements or fewer elements.

As shown in FIG. 3, the battery pack 300 can be coupled with system 325, which can include, or implement a system power supply bus 330 (e.g., VSYS and electrical ground), where power for charging the rechargeable battery 312 (charging power), as well as power supplied by the rechargeable battery 312 (discharge power) can be carried on the system power supply bus 330 (e.g., the system power supply bus 330 is a common charging and discharging bus). Also in FIG. 3, in addition to the shared system power supply bus 330, charging power paths are referenced using reference character C, and discharge power paths are referenced using reference character D. Further, power paths that carry both charging and discharging power, depending on the mode of operation, are referenced using reference character C/D, and are indicated as bidirectional, as is the path for the system power supply bus 330.

Input and output signals between the various blocks in FIG. 3 are indicated using either solid (IO) or dashed (accessory IO) lines with arrows indicating respective directions of signal communication. Depending on the particular implementation, a number of approaches can be used for communication of such signals or information between the various blocks of FIG. 3, and/or for communicating with an external host, such as device providing charging power via a USB cable. For instance, such communication can be accomplished using an Inter-integrated Circuit (I²C) bus, using a system power management interface (SPMI), and/or using other approaches, such as by communicating data over power lines.

In the example implementation of FIG. 3, when charging power is supplied to the battery pack 300 via the system power supply bus 330, e.g., from a VBUS supply voltage of a USB cable, the charging controller 340 can act as dedicated charge controller for the rechargeable battery 312. For instance, the charging controller 340 can operate as a linear charger for the rechargeable battery 312, which can be a lithium-ion, or other chemistry rechargeable battery cell. In this example, the charging controller 340 can operate in a constant-current mode, while a voltage of the rechargeable battery 312 is below a threshold voltage. Once the rechargeable battery 312 has charged to the threshold voltage, the charging controller 340 can be configured to operate in a constant-voltage mode, until an associated charging current drops to a current threshold, and charging of the rechargeable battery 312 can then be stopped.

In some implementations, a current limit for constant-current charging can be configured either at time of manufacture, through an external resistor, or can be field programmable. Likewise, a voltage limit for constant-voltage charging can be configured either at time of manufacture, or can be field programmable. Depending on the particular implementation, such current and voltage limits can be included, or stored in the charging controller 340, and/or in the non-volatile memory 346 and communicated to the charging controller 340. Such limits can be varied based on a temperature of the rechargeable battery 312, such as determined by the thermistor 347. For instance, charging current and voltage values can be changed at different temperatures to comply with industry standards. The exact temperatures and associated limits can depend on the particular implementation.

In some implementations, a voltage of the rechargeable battery 312 (as well as voltages of other batteries in an associated electronic device) can be monitored by voltage monitor 342, and the measured voltage information provided to the system 325. In some implementations, these battery cell voltages can be used (e.g., for voltage following as shown in FIG. 3) to set a voltage on the system power supply bus 330, such as a VSYS voltage, where the set voltage tracks, or follows a lowest battery cell voltage of the associated system. This information can be communicated using the approaches described herein, e.g., using either an analog output signal, or through a digital interface that, e.g., communicates with an associated power regulator.

In some implementations, voltages of different batteries included in a given electronic device can be of different values, which can occur due to differences in resistance between a system load and each respective battery. The dedicated bidirectional controllers described herein are capable of charging the lower voltage batteries at a controlled rate that can be different than a rate used to charge high voltage batteries. For instance, using the approaches described herein, each charging controller 340 can be configured to charge its respective rechargeable battery 312 based on its cell voltage, e.g., either in constant-current mode or constant-voltage mode. Accordingly, the approaches described herein allow for safely charging parallel connected batteries having different cell voltages using a single charging power supply. Such approaches can be beneficial as they can prevent the potential for continuous charging back and forth between different parallel-connected battery cells. Again, such approaches can be implemented in electronic devices including two or more parallel-connected rechargeable batteries.

In the example implementations of FIG. 3, the switch 341 and the voltage monitor 342 can operation in cooperation with one another to switch power between the charging path (used when charging battery cells) to the discharge path (when supplying power to the system 325 from the rechargeable battery 312). For instance, in this example, if the voltage monitor 342 determines that a voltage applied to system power supply bus 330 is greater than a voltage of the rechargeable battery 312, the voltage monitor 342 can direct the switch 341 to switch so as to direct power from the system power supply bus 330 to the charging path. If, however, the voltage monitor 342 determines that a voltage (e.g., an external voltage) applied the system power supply bus 330 is less than a voltage of the 312, indicating a charging power source is not connected, the voltage monitor 342 can direct the switch 341 direct power from the rechargeable battery 312 to the discharge path, e.g., to supply power to the system 325.

In some implementations, the voltage monitor 342 can implement hysteresis when switching to charging mode. For instance, the voltage monitor 342 can be configured to direct the switch 341 to direct power from the system power supply bus 330 to the charging path as result of a voltage of the system power supply bus 330 (e.g., an externally supplied voltage) being greater than a voltage of the 312 by a threshold amount, such as 200 mV for example. The hysteresis threshold, or voltage value can be fixed at time of manufacture, or field programmable, e.g., by setting a resistance value, and can be stored in the voltage monitor 342, and/or can be stored in the non-volatile memory 346 and communicated to the voltage monitor 342 using the approaches described herein.

In electronic devices including batteries that are size limited, such as the glasses 100 of FIG. 1, capacity of those batteries can also be constrained by the physical size limitations. As discussed herein, charging such batteries that are parallel-connected can include charging unbalanced balanced batteries, where respective voltages of different batteries varies when charging begins. Such imbalance can result from variations in respective load and/or charging impedances of each battery, and charging such batteries without dedicated control, as described herein, can damage one or more of the parallel-connected batteries if an associated charging current is too high. Using the approaches described herein, including a respective current monitor, such as the current monitor 343, with each parallel-connected battery can protect those batteries from such charging damage, and can provide improved cell protection as compared to current protection circuit approaches, which can have operation tolerances that are insufficient to protect such size constrained battery cells.

In example implementations, the current monitor 343 can be implemented using a comparator that determines when an associated discharging current is above a threshold (which can be set at time of manufacture, field programmable, or set by a resistor). Such a current limit can be established based on capabilities of the rechargeable battery 312. In some implementations, the current monitor 343 can be implemented using multiple steps of resistance. Depending on the particular implementation, the charging current limit implemented by the current monitor 343 can be adjusted based on temperature of the rechargeable battery 312, e.g., as determined by the rechargeable battery thermistor 347.

In some implementations, the current monitor 343 can communicate charging current and discharge current information to the fuel gauge 345. The fuel gauge 345 can integrate that current information and, in conjunction with voltage information for the rechargeable battery 312, determine a state-of-charge (SoC) of the rechargeable battery 312, which can be represented as percentage of stored charge of the rechargeable battery 312 as compared to its fully-charged capacity (e.g., one-hundred percent SoC). This fuel gauge information can then be reported to the system 325, e.g., for reporting to a user, such as via a display device.

In some implementations, the current monitor 343 of the battery pack 300 can be configured to detect an over-current event, either charging current or discharge current, and latch an indication of such an over-current event. This latched indication can be communicated to the adjustable circuit 344, which can, as a result, disconnect the rechargeable battery 312 the charging controller 340 and/or the switch 341. Such an approach can protect the rechargeable battery 312 from damage, and or prevent the occurrence of hazardous conditions, such as thermal runaway and/or an electrical fire.

As discussed herein, implementing multiple, parallel connected batteries in an electronic device can result in the respective batteries having different load and/or charging impedances. Such different impedances can result in one battery providing more current than other batteries, and could result in one or more batteries being discharged at a rate, or current that is greater than the respective batteries capabilities, which can cause damage to those batteries, and/or result in hazardous conditions. Current approaches for protecting rechargeable batteries that protect batteries from damage from over discharge (in terms of both voltage and short circuit current) operate as on off switches. In a system including multiple parallel-connected batteries, disconnecting one battery would put additional current load onto the other batteries of an associated electronic device, which can result in cascading failure of batteries. Other approaches, such as positive temperature coefficient devices may also not be sufficient as they have inaccurate current limits and react slowly. As discussed below, the approaches described herein can overcome such drawbacks.

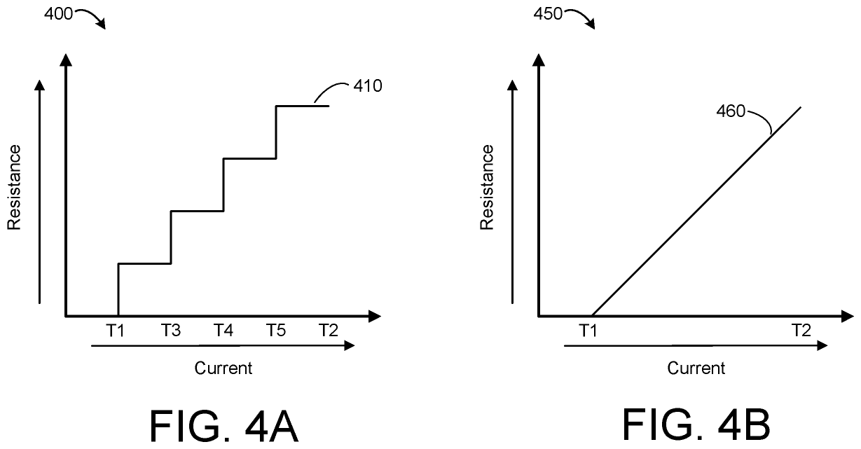

For instance, in the example of FIG. 3, when operating in discharge mode (e.g., the 312 is supplying power to the system 325 via the discharge path) the current monitor 343 can monitor the discharge current and the adjustable circuit 344 can control the discharge current, such as using the approaches described below with respect to FIGS. 4A and 4B. In situations where there is imbalance between batteries during discharge, using the example implementation of FIG. 3, batteries with higher voltages can charge batteries with lower voltages with a charging current that is controlled by the charging controller 340. Such approaches allow for batteries of different capacities to be parallel-connected to power an electronic device, and allows for flexibility in locating those batteries in the device due to the use of a common power supply bus for charging and discharging.

In some implementations, a current sense resistor can be included in, e.g., the current monitor 343. The voltage monitor 342 can be used to measure a voltage across the current sense resistor to determine a charging current or a discharge current of the rechargeable battery 312. While in the discharge mode, if the discharge current reaches a threshold value, the adjustable circuit 344 can instruct the adjustable circuit 344 increase its resistance to limit the discharge current. Example approaches for increasing resistance of the adjustable circuit 344 are illustrated in FIGS. 4A and 4B, and discussed below. The current sense resistor information can also be provided to the fuel gauge 345 for use in SoC determination.

As discussed above, the non-volatile memory 346 can be used to store configuration information of a bidirectional controller, such as in the example of the FIG. 3. Such configuration information can include voltage hysteresis information for the voltage monitor 342, current limits for the current monitor 343, current hysteresis information for the adjustable circuit 344, and/or battery cell information, such as storage and/or current capacity, for the rechargeable battery 312

FIGS. 4A and 4B are graphs 400 and 450 that schematically illustrate respective approaches for discharge current control in the system of FIG. 2 and/or the controller of FIG. 3. Specifically, the graphs 400 and 450 illustrate resistance of an adjustable resistance circuit, such as the circuit 344 of FIG. 3, as function of discharge current of an associated battery. In the examples of FIGS. 4A and 4B, a threshold T1 is used to indicate a threshold current at which current control can be triggered, and a threshold T2 is used to indicate a threshold current at which an associated battery can be disconnected from VSYS, e.g., to prevent damage to the battery, or hazardous conditions that can result from an overcurrent situation. In some implementations, prior to the threshold T1 being reached, an adjustable resistance circuit can operate in pass-through mode, e.g., at zero resistance.

As shown in FIG. 4A, after discharge-current control of an associated battery is triggered at threshold T1, if discharge current of the battery still continues to increase, a corresponding resistance of an adjustable resistance circuit can be increased in step-wise fashion, with increases in resistance occurring at currents of a thresholds T3, T4 and T5, as illustrated by the trace 410. As noted above, if the battery discharge current reaches the threshold T2, the adjustable resistance circuit can, in response, disconnect the battery from an associated power supply bus (VSYS) to prevent damage and or hazardous conditions.

As shown in FIG. 4B, after discharge-current control of an associated battery is triggered at threshold T1, if discharge current of the battery still continues to increase, a corresponding resistance of an adjustable resistance circuit can be linearly increased, as shown by the trace 460. As illustrated by the graph 450 of FIG. 4B, if the battery discharge current reaches the threshold T2, a corresponding battery can, in response, be disconnected from an associated power supply bus (VSYS) to prevent damage and or hazardous conditions.

In some implementations, the adjustable circuit 344 can be implemented using hysteresis between the current thresholds, which can prevent resistance of the adjustable circuit 344 from oscillating. In some implementations, such as the example of FIG. 4A, step-wise resistance increases can be on the order of 10s of milliohms to hundreds of milliohms, and can depend on the particular implementation.

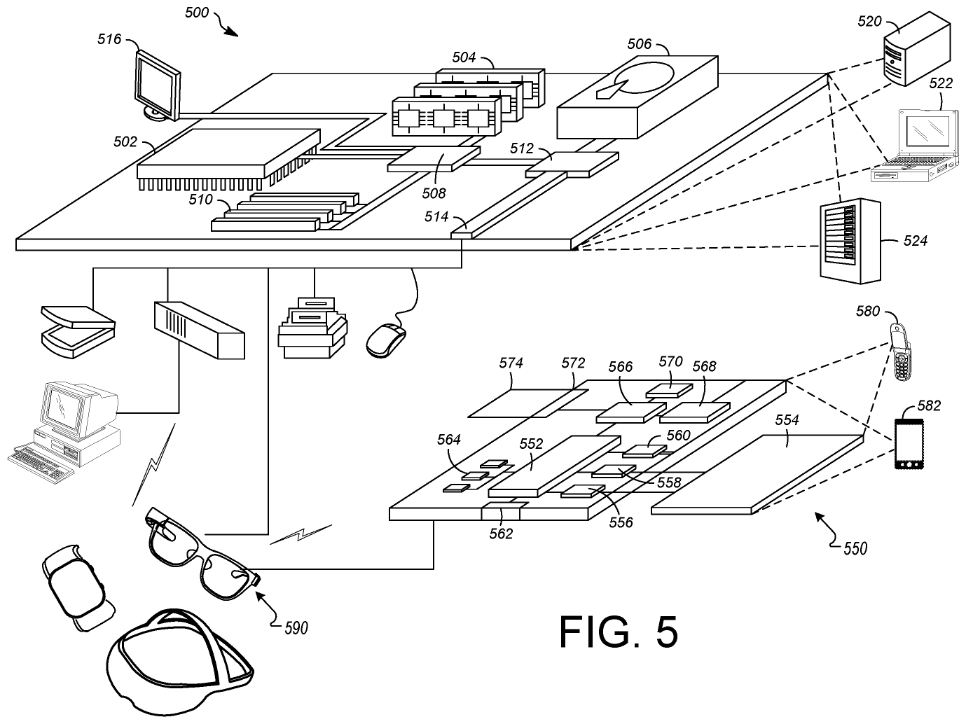

FIG. 5 illustrates an example of a computer device 500 and a mobile computer device 550, which may be used with, may be used to implement, or may include the techniques and devices described here (e.g., to implement the client computing device 100, the charging system 200, and/or the charge/discharge controller 300). The computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low-speed controller 512 manages lower bandwidth-intensive operations. Such allocation of functions is example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display), and LED (Light Emitting Diode) or an OLED (Organic Light Emitting Diode) display, or other appropriate display technology. The display interface 556 may include appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In-Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, Wi-Fi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 5 can include sensors that interface with an AR headset/HMD device 590 to generate an augmented environment for viewing inserted content within the physical space. For example, one or more sensors included on a computing device 550 or other computing device depicted in FIG. 5, can provide input to the AR headset 590 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 550 can use the sensors to determine an absolute position and/or a detected rotation of the computing device in the AR space that can then be used as input to the AR space. For example, the computing device 550 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 550 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 550 when the computing device is incorporated into the AR space can cause a particular action to occur in the AR space.

In some implementations, a touchscreen of the computing device 550 can be rendered as a touchpad in AR space. A user can interact with the touchscreen of the computing device 550. The interactions are rendered, in AR headset 590 for example, as movements on the rendered touchpad in the AR space. The rendered movements can control virtual objects in the AR space.

In some implementations, one or more output devices included on the computing device 550 can provide output and/or feedback to a user of the AR headset 590 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 550 may appear as another object in a computer-generated, 3D environment. Interactions by the user with the computing device 550 (e.g., rotating, shaking, touching a touchscreen, swiping a finger across a touch screen) can be interpreted as interactions with the object in the AR space. In the example of the laser pointer in an AR space, the computing device 550 appears as a virtual laser pointer in the computer-generated, 3D environment. As the user manipulates the computing device 550, the user in the AR space sees movement of the laser pointer. The user receives feedback from interactions with the computing device 550 in the AR environment on the computing device 550 or on the AR headset 590. The user's interactions with the computing device may be translated to interactions with a user interface generated in the AR environment for a controllable device.

In some implementations, a computing device 550 may include a touchscreen. For example, a user can interact with the touchscreen to interact with a user interface for a controllable device. For example, the touchscreen may include user interface elements such as sliders that can control properties of the controllable device.

Computing device 500 is intended to represent various forms of digital computers and devices, including, but not limited to laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A smart glasses system comprising:
a frame including:
a first temple;
a second temple; and
a lens portion;
a first battery cell included in the first temple;
a second battery cell included in the second temple;
a system power bus coupled with the first battery cell and the second battery cell, the system power bus being included in the frame;
a system load coupled with the system power bus, the system load including at least one component of the smart glasses system;
a first bidirectional controller operationally coupled between the system power bus and the first battery cell, the first bidirectional controller being configured to:
control a charging current and a charging voltage of the first battery cell; and
control a discharge current of the first battery cell; and
a second bidirectional controller operationally coupled between the system power bus and the second battery cell, the second bidirectional controller being configured to:
control a charging current and a charging voltage of the second battery cell; and
control a discharge current of the second battery cell.

2. The smart glasses system of claim 1, wherein:
the first battery cell and the first bidirectional controller are included in the first temple; and/or
the second battery cell and the second bidirectional controller are included in the second temple.

3. The smart glasses system of claim 1, wherein the system power bus includes a power regulator included in a bridge portion of the lens portion,
the power regulator being coupled with the first battery cell via the bridge portion, a rim portion of the lens portion, and the first temple, and/or
the power regulator being coupled with the second battery cell via the bridge portion, a second rim portion of the lens portion, and the second temple.

4. The smart glasses system of claim 1, wherein the first bidirectional controller includes:
a current monitor configured to monitor a discharge current of the first battery cell.

5. The smart glasses system of claim 4, further comprising an adjustable resistance circuit operationally coupled with the current monitor, the current monitor and the adjustable resistance circuit being collectively configured to, when charging the first battery cell, to:
limit the discharge current in response to the discharge current exceeding a first current threshold; and/or
disconnect the first battery cell from the system power bus in response to the discharge current exceeding second current threshold, the second current threshold being greater than the first current threshold.

6. An electronic device comprising:
a first battery cell;
a second battery cell;
a system power bus;
a system load coupled with the system power bus;
a first bidirectional controller operationally coupled between the system power bus and the first battery cell, the first bidirectional controller being configured to:
control a charging current and a charging voltage of the first battery cell; and
control a discharge current of the first battery cell; and
a second bidirectional controller operationally coupled between the system power bus and the second battery cell, the second bidirectional controller being configured to:
control a charging current and a charging voltage of the second battery cell; and
control a discharge current of the second battery cell.

7. The electronic device of claim 6, further comprising a power regulator operationally coupled with the system power bus, the power regulator being configured to:
receive electrical power from an external power source;
regulate the received electrical power; and
provide the regulated electrical power to:
the first bidirectional controller for charging the first battery cell; and/or
the second bidirectional controller for charging the second battery cell.

8. The electronic device of claim 6 or 7, wherein the first bidirectional controller includes:
a voltage monitor configured to compare a voltage applied to the system power bus with a voltage of the first battery cell and provide a comparison signal based.

9. The electronic device of claim 8, further comprising a switch operationally coupled with the voltage monitor, the switch being configured, based on the comparison signal, to change between a charging mode of the first battery cell and a discharging mode of the first battery cell.

10. The electronic device of claim 6, wherein the first bidirectional controller includes:
a charge controller configured, when charging the first battery cell, to:
charge the first battery cell using a constant current while a voltage of the first battery cell is a less than or equal to a threshold voltage.

11. The electronic device of claim 10, wherein the charge controller is configured to charge the first battery cell using a constant voltage while the voltage of the first battery cell is above the threshold voltage and a charging current is greater than a current threshold.

12. The electronic device of claim 6, wherein the first bidirectional controller includes:
a current monitor configured to monitor a discharge current of the first battery cell; and
an adjustable resistance circuit operationally coupled with the current monitor, the current monitor and the adjustable resistance circuit being collectively configured to, when charging the first battery cell, to:
limit the discharge current in response to the discharge current exceeding a first current threshold; and/or
disconnect the first battery cell from the system power bus in response to the discharge current exceeding second current threshold, the second current threshold being greater than the first current threshold.

13. The electronic device of claim 6, wherein the first battery cell has first capacity and the second battery cell has a second capacity that is different than the first capacity.

14. The electronic device of claim 6, wherein the system load includes at least one component of a smart glasses system.

15. The electronic device of claim 6, wherein the electronic device is included in a smart glasses system of claim 1 such that the first battery cell is included in the first temple, the second battery cell is included in the second temple and the system power bus in included in the frame.

16. A method for controlling battery charging and discharging in an electronic device having a first battery cell, a second battery cell, a system power bus and a system load coupled with the system power bus, the method comprising:
with a first bidirectional controller operationally coupled between the system power bus and the first battery cell:
controlling a charging current and a charging voltage of the first battery cell; and
controlling a discharge current of the first battery cell; and
with a second bidirectional controller operationally coupled between the system power bus and the second battery cell:
controlling a charging current and a charging voltage of the second battery cell; and
controlling a discharge current of the second battery cell.

17. The method of claim 1616, further comprising, with a power regulator operationally coupled with the system power bus:
receiving electrical power from an external power source;
regulating the received electrical power; and
providing the regulated electrical power to:
the first bidirectional controller for charging the first battery cell; and/or
the second bidirectional controller for charging the second battery cell.

18. The method of claim 16, further comprising:
comparing, using a voltage monitor included in the first bidirectional controller, a voltage applied to the system power bus with a voltage of the first battery cell and provide a comparison signal based; and
optionally changing, using a switch operationally coupled with the voltage monitor, between a charging mode of the first battery cell and a discharging mode of the first battery cell.

19. The method of claim 16, further comprising, when charging the first battery cell:
charging, using a charge controller included in the first bidirectional controller, the first battery cell using a constant current while a voltage of the first battery cell is a less than or equal to a threshold voltage; and
optionally charging, using the charge controller, the first battery cell using a constant voltage while the voltage of the first battery cell is above the threshold voltage and a charging current is greater than a current threshold.

20. The method of claim 16, further comprising, when discharging the first battery cell:
monitoring, with a current monitor included the first bidirectional controller, a discharge current of the first battery cell;
limiting the discharge current in response to the current monitor indicating that the discharge current exceeds a first current threshold; and/or
disconnecting the first battery cell from the system power bus in response to the current monitor indicating that the discharge current exceeds second current threshold, the second current threshold being greater than the first current threshold.

21. The method of claim 20, wherein limiting the discharge current includes limiting the discharge current using a variable resistance circuit.

22. The method of claim 20, wherein disconnecting the first battery cell from the system power bus includes disconnecting the first battery cell from the system power bus using a disconnect circuit.

23. The method of claim 16, wherein the first battery cell has first capacity and the second battery cell has a second capacity that is different than the first capacity.

24. The method of claim 16, wherein the system load includes at least one component of a smart glasses system.

25. The method of claim 16, wherein the electronic device is the electronic device claimed in claim 5.
